(19) United States
(12) Patent Application Publication
(10) Pub. No.: US 2005/0222752 A1
(43) Pub. Date: Oct. 6, 2005

(54) Method for enabling communications dependent on user location, user-specified location or orientation

(76) Inventors: Raymond L. Sokola, Long Grove, IL (US); Michael A. Newell, Williams Bay, WI (US); Robert F. D'Avello, Lake Zurich, IL (US); Scott B. Davis, Walworth, WI (US); Nick J. Grivas, Harvard, IL (US); Jerome D. Meyerhoff, Buffalo Grove, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,109

(22) Filed: Apr. 5, 2004

(51) Int. Cl. G01C 21/26

(52) U.S. Cl. 701/200; 701/205

(57) ABSTRACT

A system and method for enabling communications in a wireless communications network on the basis of user-specified locations or orientations, having particular utility to vehicle-based communications. Users of the network broadcast their locations and orientations (headings) to a central server. Using his user interface, a user can specify either a location or a heading and transmit the same to the server. The server will query other system users to determine which correspond to the specified locations or orientations, and the requesting user is then permitted to contact such other users. With such functionality, a given user can, for example, be enabled to communicate with other users at or near his current location, at or near some specified distant location, or that are traveling in the same direction as the user.

The present application is related to the following co-pending, commonly assigned patent applications, which were filed concurrently herewith and incorporated by reference in their entirety:
Ser. No. ______, entitled “Selectively Enabling Communications at a User Interface Using a Profile,” attorney docket TC00167, filed concurrently herewith.
Ser. No. ______, entitled “Methods for Sending Messages Based on the Location of Mobile Users in a Commnunication Network,” attorney docket TC00169, filed concurrently herewith.
Ser. No. ______, entitled “Methods for Displaying a Route Traveled by Mobile Users in a Communication Network,” attorney docket TC00170, filed concurrently herewith.
Ser. No. ______, entitled “Conversion of Calls from an Ad Hoc Communication Network,” attorney docket TC00172, filed concurrently herewith.
Ser. No. ______, entitled “Method for Entering a Personalized Communication Profile Into a Communication User Interface,” attorney docket TC00173, filed concurrently herewith.
Ser. No. ______, entitled “Methods and Systems for Controlling Communications in an Ad Hoc Communication Network,” attorney docket TC00174, filed concurrently herewith.
Ser. No. ______, entitled “Methods for Controlling Processing of Inputs to a Vehicle Wireless Communication Interface,” attorney docket TC00175, filed concurrently herewith.
Ser. No. ______, entitled “Methods for Controlling Processing of Outputs to a Vehicle Wireless Communication Interface,” attorney docket TC00176, filed concurrently herewith.
Ser. No. ______, entitled “Programmable Foot Switch Useable in a Communications User Interface in a Vehicle,” attorney docket TC00177, filed concurrently herewith.

### FIELD OF THE INVENTION

This invention in general relates to systems and methods for enabling communications in a wireless communications network on the basis of user-specified locations or orientations, having particular utility to vehicle-based communications.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Star™ is a well-known communication system currently employed in vehicles, and allows vehicle occupants to establish a telephone call with others (such as a service center) by activating a switch.

However, existing communications schemes lack flexibility to tailor group communications and allow users to dynamically move between communications. For instance, existing approaches depend heavily on establishing communication from one end of a communication (namely, a service center) and do not provide means for all parties to dynamically change the nature of the communications or the definition of the group. This lack of flexibility may prohibit group users from communicating as freely as they might wish.

A need exists for more flexibility in wireless communications, especially in the automotive environment. But simply adding more flexibility can make a communication system unwieldy. In a large public communications network, many group conversations might be held, each on its own channel, and a particular user may be capable of joining a plurality or all of such conversations. Thus, a user may be overwhelmed at the conversation options open to him.

In certain circumstances, a first user may only wish to publicly communicate with a second user on the basis of either the location of the first or the location of the second user. For example, the first user may only wish to speak to second users close to him (e.g., within a particular suburb), or may wish to communicate only with second users present at some other location remote from the first user (e.g., at a ball park). Moreover, the first user may only be interested to speak with second users traveling in his same direction. For example, the first user, traveling along a highway, may be interested to know what traffic conditions are like ahead, and might like to speak to a second user traveling ahead of him (or behind him) along the same route.

In short, there is much about the organization of vehicle wireless-based communications systems that could use improvement to enhance its functionality, and to better utilize the resources that the system is capable of providing. This disclosure presents several different means to so improve these types of communications.

It is, therefore, desirable to provide a procedure for enabling communications in a wireless communications network on the basis of user-specified locations or orientations, having particular utility to vehicle-based communications.

### BRIEF DESCRIPTION OF THE DRAWINGS

FIG. 1 is a block diagram of a wireless vehicular communications system;

FIG. 2 is a block diagram of a control system for a vehicular wireless communications system;

FIG. 3 is a diagram illustrating various users capable of communicating on the disclosed system, along with their locations and orientations;

FIG. 4 is a diagram illustrating the server in the system and one embodiment of storing locations and headings for each of the users of the system;

FIG. 5a is a diagram illustrating various users capable of communicating with each other within a geographic area;

FIG. 5b is another diagram illustrating various users capable of communicating with each other within predefined cells and super cells;

FIG. 6a is one embodiment of a display in a user interface for defining a communication area around the user to allow that user to communicate with other users within the area;

FIG. 6b illustrates the display of FIG. 6a that shows which users in the system fall within the area and with which communications can be established;

FIG. 6c illustrates a display of a user within the area, providing an option to accept or decline to communicate with the requesting user;

FIG. 7 illustrates a display in a user interface for defining a communication location to allow a user to communicate with other users substantially near that location, wherein the location may be remote from the user;

FIG. 8a illustrates a display in a user interface for defining a heading to allow a user to communicate with other users having substantially the same (or opposite) headings as the first user;

FIG. 8b illustrates a modification to the display of FIG. 8a which allows the user to further define a communication area ahead of or behind the user;

FIG. 9a illustrates a group of users traveling together on a trip and communicating together on a group call, and showing the definition of communication area(s) around them;

FIG. 9b illustrates a display in a user interface for defining a communication area around the group of user of FIG. 9a and for specifying how the area should be determined; and

FIG. 9c illustrates the display of FIG. 9b and showing which users in the system fall within the area and with which communications can be established.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is an improved system and procedure enabling communications in a wireless communications network on the basis of user-specified locations or orientations. Users of the network broadcast their locations and orientations (headings) to a central server. Using his user interface, a user can specify either a location or a heading and transmit the same to the server. The server will query other system users or otherwise determine which users correspond to specified locations or orientations, and the requesting user is then permitted to contact such other users. With such functionality, a given user can, for example, be enabled to communicate with other users at or near his current location, at or near some specified distant location, or that are traveling in the same direction as the user.

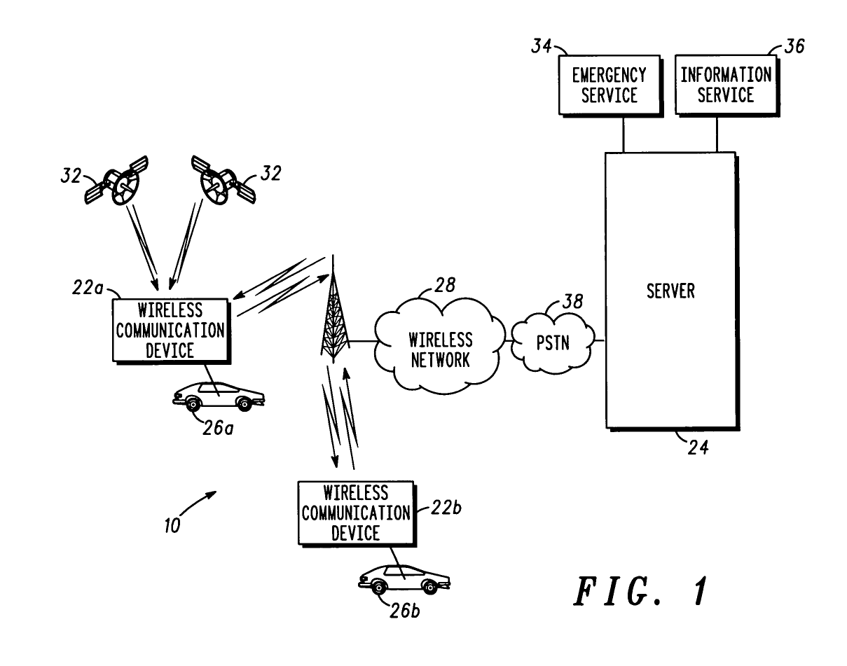

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of both transmitting and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, the network may be coupled to a public switched telephone network (PSTN) 38, the Internet, or other communication network on route to a service center having a server 24, which ultimately acts as the host for communications on the communication system 10 and may comprise a communications server. As well as administering communications between vehicles 26 wirelessly connected to the system, the server 24 can provide other services to the vehicles 26, such as emergency services 34 or other information services 36 (such as restaurant services, directory assistance, etc.).

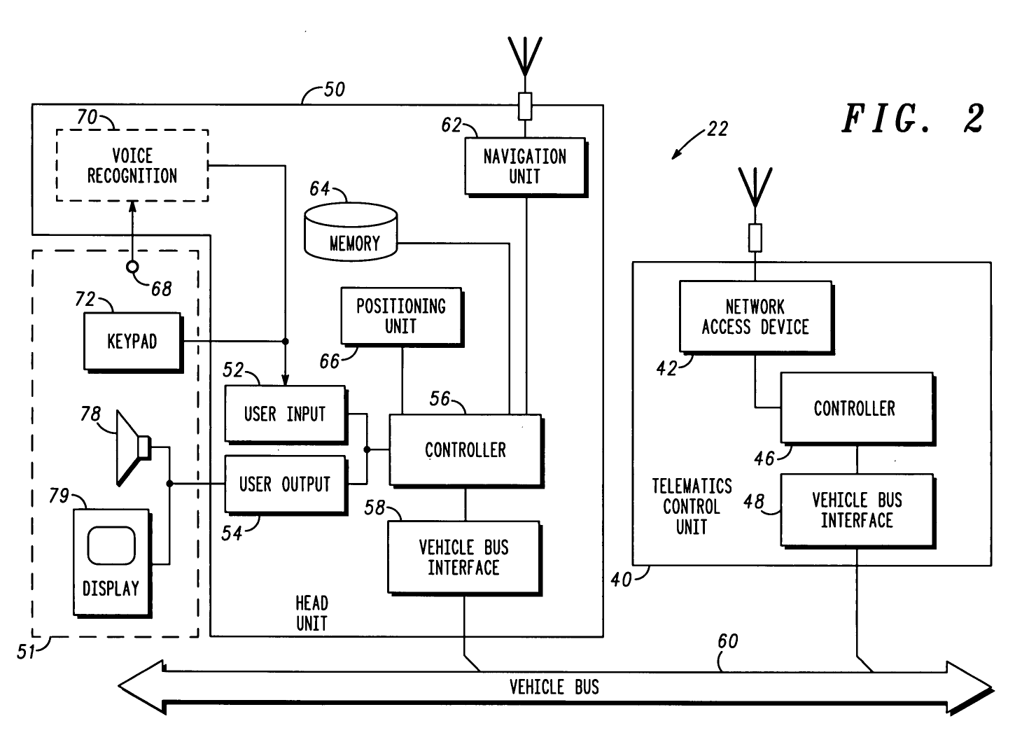

Further details of the wireless communications device 22 as employed in a vehicle 26 are shown in FIG. 2. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles that are wirelessly coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 can also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 28, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, a user in the second vehicle 26b can, in like fashion, communicate back to the first vehicle 26a, with the speaker's voice being heard on speaker(s) 78 in the first vehicle or converted to text and shown on display 79. Or, an occupant in the first vehicle 26a can call the service center and server 24 to receive services. Additionally, such a system 10 can have utility outside of the context of vehicle-based applications, and specifically can have utility with respect to other portable devices (cell phones, personal data assistants (PDAs), etc.). The use of the system in the context of vehicular communications is therefore merely exemplary.

System 10 can be used by a vehicle user to engage in group conversations, in what we will refer to as an “ad hoc” communication network. In such an application, a plurality of users in communication with the system may join into a public conversation. In such a system, a subset of users would be predefined by a system user to form a communication group, such as a family group, a professional work group, etc. Once predefined, any of those predefined users would be able to speak with other predefined users, for example, by pressing a push-to-talk button on their user interfaces, which again may constitute a dedicated vehicular user interface, or by simply speaking and activating a voice activated circuit. All other users in the predefined group will hear the voice of the speaking user, and in turn all users may likewise speak with the rest of the users in the group in a like manner.

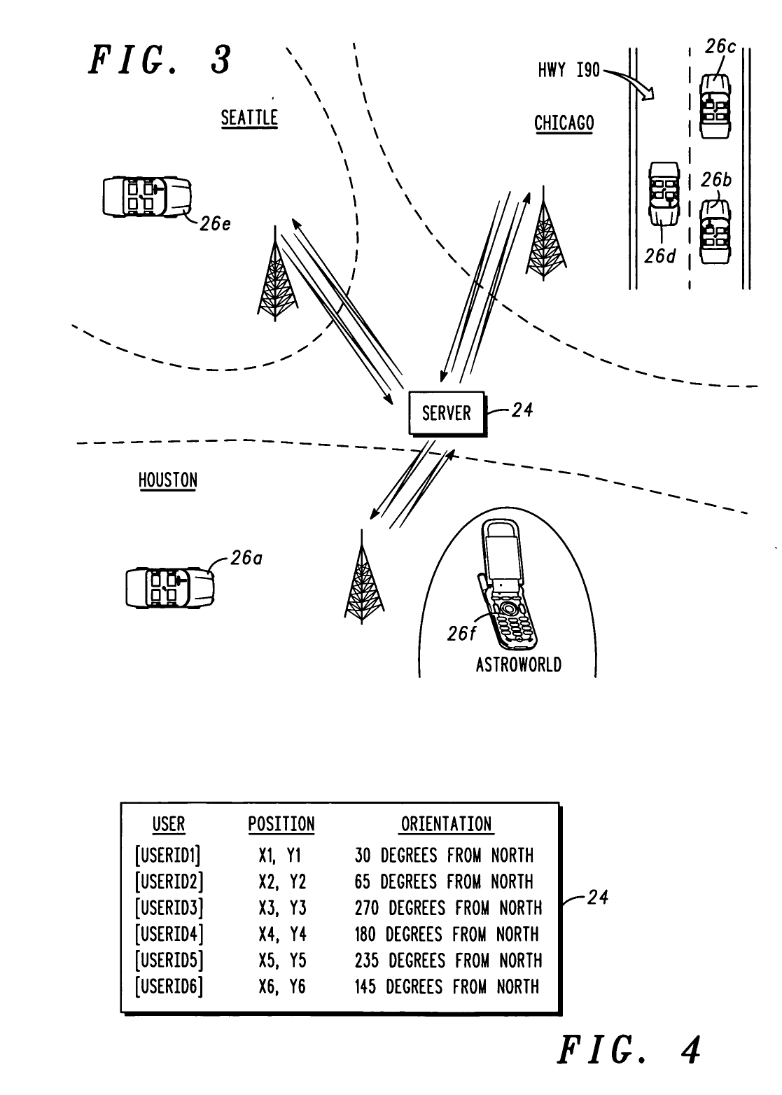

FIG. 3 shows various users each able to potentially communicate with the system. Six users are shown in this simple example, each being located in three different regions of the country: Houston, Chicago, and Seattle. All users have user interfaces 51 similar to those disclosed in FIG. 2, except that user 26f's user interface 51 is contained within a cell phone (or PDA) and hence is not integral with a vehicle; it otherwise functions similarly to the user interfaces 51 in the vehicles absent of course functionality specific to vehicles. Users 26a and 26f are in Houston, and user 26f is located within an amusement park. Users 26b-d are in Chicago, and more specifically users 26b and 26c are traveling northbound on Interstate 90, while user 26d is traveling southbound. User 26eis in Seattle.

The various ways in which the users 26 can participate in or receive communications from other user is dictated on the basis of their locations and/or orientations (headings). The locations and/or headings of user 26a-f (and any other users connected to the system 10) are tracked by the server 24. In this regard, the Telematics control unit 40 may automatically transmit to the server 24 information regarding the location (e.g., longitude/latitude), heading (or orientation), and identity of the users on a periodic basis. Referring again briefly to FIG. 2, location information is provided by the navigation unit 62 in the head unit 50, and may constitute provision of the longitude/latitude coordinates through the use of a Global Positioning System (GPS). Moreover, the head unit 50 further contains a positioning unit 66 capable of detecting the first vehicle's heading (deviation from north, etc.), essentially providing electronic compass readings. Receipt of such information at the server 24 is accompanied by a given user's user ID. The user ID can be included in the transmission by the controller 56 and can comprise a “handle,” a Vehicle Identification number (VIN), an Electronic Serial Number (ESN), an International Mobile Subscriber Number (IMSI), or a Mobile Subscriber International ISDN Number (MSISDN), all of which are referred to herein as “user IDs” for convenience. Such location, heading, and identity information for a particular user may be formatted in any number of ways, such as in a data header in a predictable format so the header will be easily interpreted by the server 24. Either way, at least the current location and heading information (and possibly past history data) are stored for each of the users at the server 24, as shown in FIG. 4. Additionally, the server 24 may also determine or calculate location or heading information about a specific user 26 based on information from various cellular base stations in the proximity of the user 26. This can be done by triangulating information such as signal strength of communications of the user with the plurality of cellular base stations or the server 24 may store general location information based on the cell site that a user is communicating.

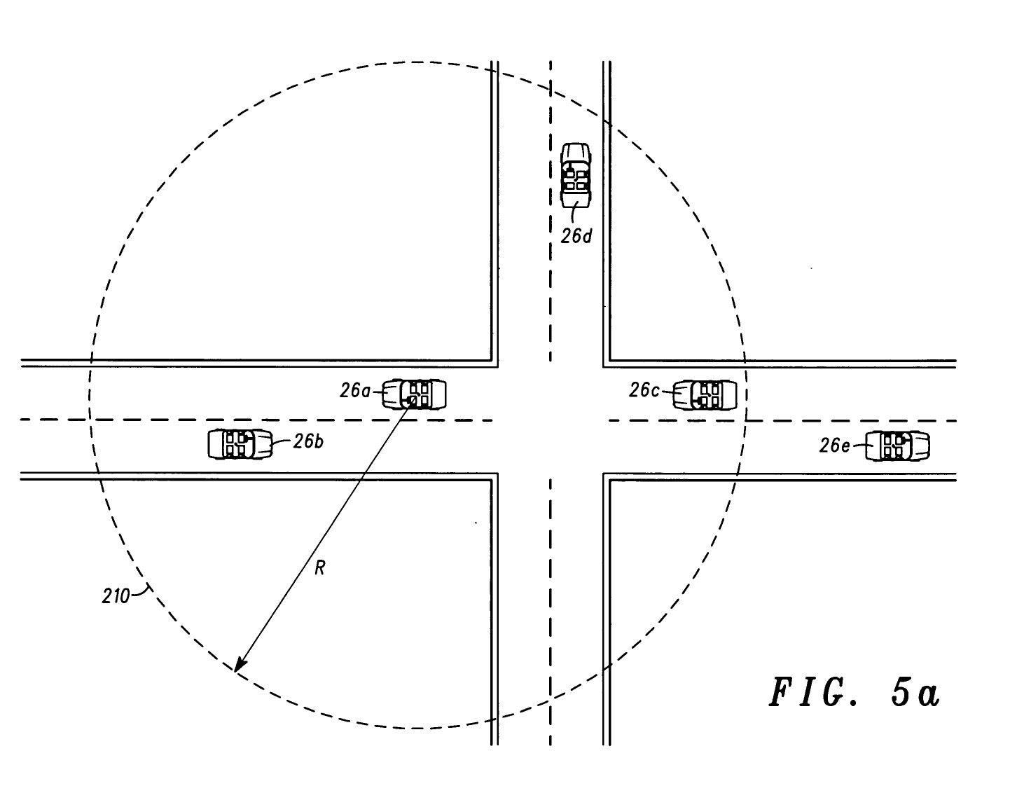

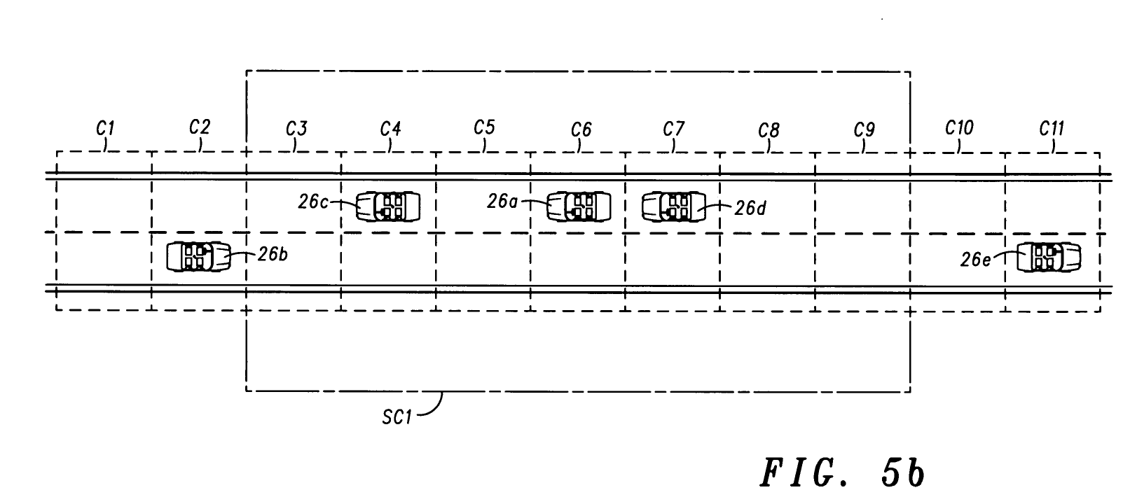

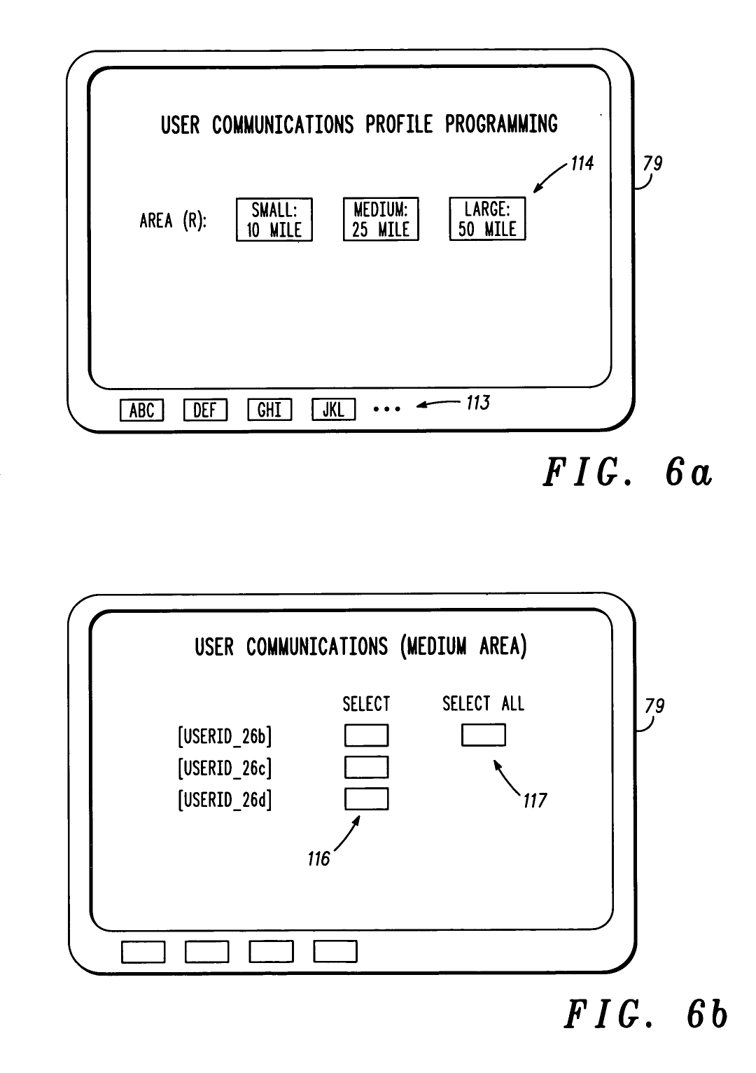

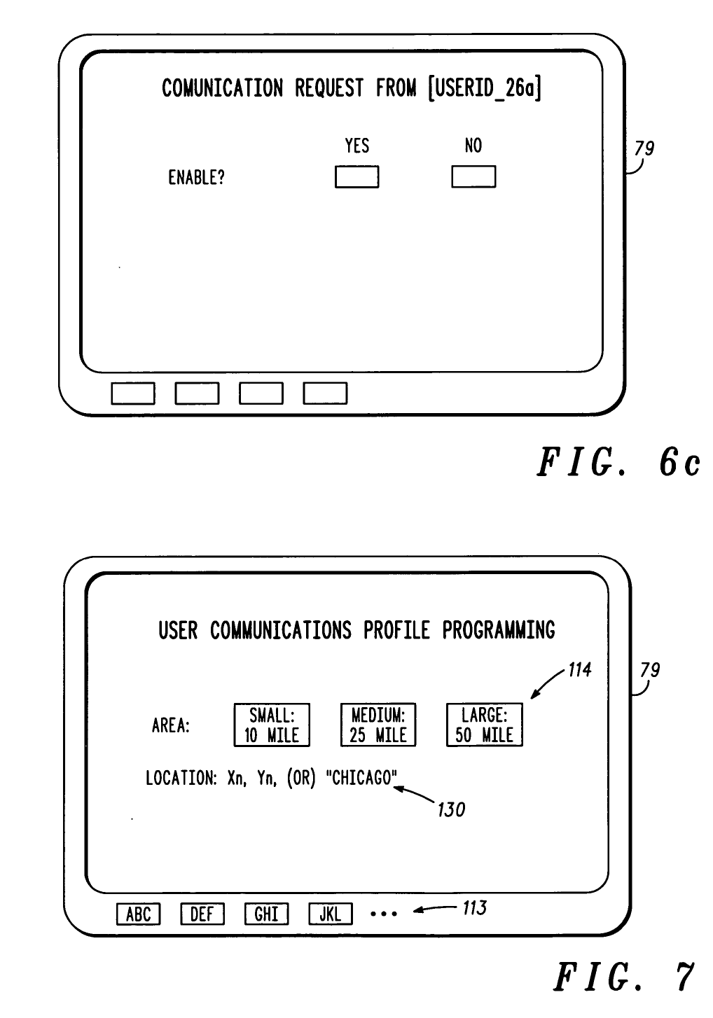

Receipt of such information at the server 24 allows communications to be tailored for individual users based on a location or heading (orientation). For example, referring to FIG. 5a, suppose user 26a wishes to communicate only with people near to her location in an area 210, perhaps to discuss whether anyone knows of a gas station close by having cheap gas. User 26a may use her user interface to select an area limitation, as shown in FIG. 6a. Selection of an area limitation, and/or definition of a communication area around user 26a may be accomplished in a number of different ways. As shown, user 26a may select a radius (R) around her current location (X2, Y2), which may be small (10 miles), medium (25 miles), or large (50 miles), and which is selectable through the use of touch screen buttons 114. Alternatively, once user 26a's selection is made (small, medium, or large) and communicated to the server 24, the server 24 may itself define an appropriate area around user 26a in accordance with default rules. Such an area can be dictated by a radius around the user, or could constitute areas or cells around the user, or other natural subdivisions of the communication network which the server 24 can easily keep track.

The embodiment described in relation to FIG. 5a will work well for systems that need to allow users to define their own coverage areas. In a further embodiment, the area may be predefined at the system level. As will be seen in the next embodiment, the advantage of a predefined system is that it reduces system complexity caused by multiple users, each have dynamically changing areas that the system must track and individually reconfigure. Accordingly, FIG. 5b illustrates one embodiment where a segment of highway is divided up into a number of geographic cells C1-C11. These cells may be predefined as square, rectangular or circular in nature. In this embodiment, assume a highway is divided up into 11 geographically based cells, each about a mile long and at least as wide as the highway. For each cell C1-C11, the server 24 may establish an associated first channel and an associated second channel. The first channel associated with a cell may be a source audio channel that receives any audio transmitted from users within the cell. For example, referring to FIG. 5b, the first channel associated with cell C6 would receive any audio transmitted from user 26a; the first channel associated with cell C2 would receive any audio transmitted from user 26b; the first channel associated with cell C4 would receive any audio transmitted from user 26c; the first channel associated with cell C7 would receive any audio transmitted from user 26d; and the first channel associated with cell C11 would receive any audio received from user 26e.

The second channel associated with a cell may be an audio channel transmitted from the server to users within a geographic cell. In other words, the server 24 receives audio from the first channels within the cells and would then mix the audio, according to predefined parameters, and transmit the audio back to users based on the cell in which the user is located. The parameters used to mix any received audio may include a scheme based on a larger region, such as the super cell SC1 showing in FIG. 5b. In this case, the system designer may wish that the second channel for each cell include the audio received in three cells ahead and three cells behind a given cell. For instance, a super cell SC1 may be associated with the cell C6. In other words, the server 24 may mix the audio received from the first channels of cells C3-C9 (three miles behind cell C6 and three miles ahead of cell C6) and transmit the mixed audio to any user within cell C6 (such as user 26a) over the second channel associated with cell C6. Likewise, for cell C4, the server 24 may mix the audio received from the first channels of cells C1-C7 (three miles behind cell C4 and three miles ahead of cell C4) and transmit the mixed audio to any user within cell C4 (such as user 26c) over the second channel associated with cell C4.

To limit the amount of data mixed for a given super cell, in a further embodiment, the server 24 may initially determine whether any audio is being received from a given cell and exclude data from a cell that no audio is being transmitted. For example, referring to cell C6 in FIG. 5b, if audio is only being received from users 26c, 26a, and 26d in cells C4, C6, and C7, then the audio received over the first channel in these cells may be set to an active state. The signals from the first channels in the remaining cells (C3, C5, C8, C9) would be set to an inactive state. Accordingly, the mixing of audio for transmission over the second channel of cell C6 would only include the audio or data received from cells C4, C6, and C7.

Moreover, if users from more than one cell are transmitting at the same time, a priority scheme may be employed based on geographic location. For example, users within the same cell may have priority over users in adjacent cells. Additionally, if more than one user is speaking within a given cell, another priority scheme may be employed that is based on pre-assigned priorities for user. For example, a user that is associated with an emergency vehicle may be afforded greater priority than other general users. In a like manner, the server 24 could use priority information associated with the audio on the first channel from each cell within the super cell to select the audio to be transmitted on the second channel.

Regardless of how the area around user 26b is defined, referring back to the embodiment in FIG. 5a, the server 24 may ultimately query the positions of other users in the communication network to see which fall within the boundaries of that defined area (e.g., users 26b, 26c, and 26d—but not user 26e). This determination being made, the server 24 informs user 26a of the identity of those users by wirelessly transmitting their user IDs to user 26a. Such received user IDs are preferably display on user 26a's display 79 as shown in FIG. 6b. At this point, user 26a can choose one or more of users 26b, 26c, or 26d by selecting touch screen buttons 116. In a preferred embodiment, selection of each user causes the associated button 116 to become highlighted. Alternatively, a “select all” touch screen button 117 can be used to select all of the displayed users. In any event, once selected, user 26a may thereafter, for example, depress her push-to-talk button to speak to such users on the network. User 26a's request to communicate may be forced upon the contacted users, or more preferably the communication request is presented to and can be rejected or enabled by them. This is shown in FIG. 6c, which shows the display 79 at (e.g.) user 26c's user interface 51. If enabled, the newly connected users may now communicate with a group or a specific user 26a, for example, by pressing push-to-talk buttons (not shown) associated with their user interfaces 51.

In an alternative embodiment, a user may select a particular location remote from his present location. For example, referring back to FIG. 3, suppose user 26e(in Seattle) will be traveling to Chicago and would like to know what the weather is like there. User 26ecan use his display to enter that area (“Chicago”) or coordinates (Xn, Yn) indicative of the area in Chicago to which he will be traveling, as indicated by element numeral 130 in FIG. 7. Textual entries (“Chicago”) can be entered using alpha buttons 113, which employ schemes similar for entering names into cell phone as is well known. If a textual location is entered and sent to the server 24, a mapping program resident on the server can be used to convert the textual location into coordinates more easily interpreted by the system. Or, user 26ecould pull up a map of the Chicago area on his display and choose location coordinates from that point. Again, there are many different ways in which user 26ecould define a particular remote location, and the above examples are merely illustrative. Furthermore, definition of an area around the specified location can also be utilized (114) as previously discussed, or can be automatically generated by the server 24, etc.

In any event, once such location information is received at the server 24, the server 24 can again query the presently stored locations of each of the users to find out which are substantially near that location, such as users 26b-d. Accordingly, those users can be displayed on user 26e user interface to allow user 26e to attempt communication with some or all of them. This technique might also be used for example to allow users to communicate with users (such as user 26f) at a certain location (such as at Astroworld in Houston) to check the crowd level at the park for example.

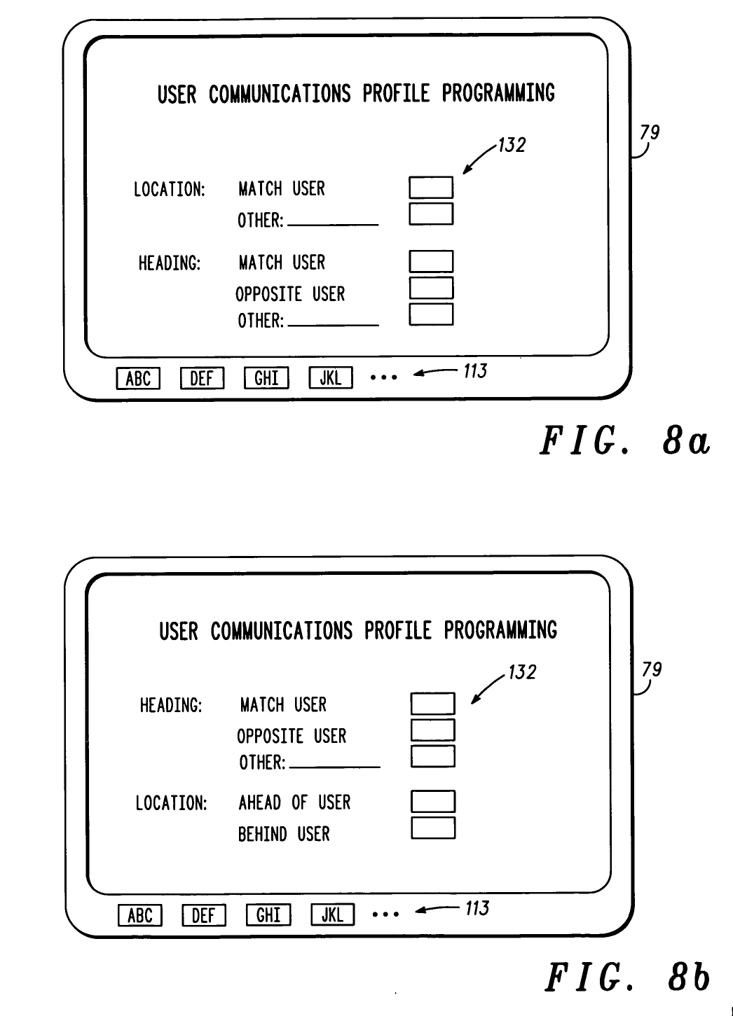

In another embodiment, both location and orientation are used to define a subset of users for communication. For example, referring again to FIG. 3, suppose user 26b, who is traveling north on Interstate 90 in Chicago, wishes to speak with other users traveling in the same direction and who therefore may have information regarding traffic conditions ahead. In such an embodiment, user 26b would specify not only a location (either his present location or another location), but would also specify some indication concerning desired orientation, as illustrated in FIG. 8a. As shown, the user can select a heading using touch screen buttons 132. The heading can either match the heading of user 26b (which would allow a conversation regarding northbound traffic), can be opposite of the heading of user 26b (southbound traffic), or can specify some other orientation specified by user 26b. Of course, merely specifying heading information would not usually sufficiently narrow the potential subset of users to those of interest to user 26b. Accordingly, options are also provided to give user 26b flexibility to define the pertinent location. For example, user 26b can specify interest to converse with users substantially matching his location, and areas and/or radius can be appropriately defined around user 26 as described earlier. Or, user 26b can specify a remote location. This could be useful in an application where user 26b is interested to know about traffic conditions in a remote area (e.g., 100 miles ahead).

In any event, and as before, upon receipt of these communication preferences from user 26b, the server 24 will query its database for users substantially meeting these criteria. Just as a specified location is preferably treated in accordance with an area around the location, relevant headings are also preferably specified within sensible limits. Thus, the server 24 in querying for matching users may use a range of headings (e.g., user 26b's heading plus or minus 10 degrees) to deem as relevant those users having substantially the same heading, a point recognizing that users traveling in the same general direction may not have exactly the same trajectory. Assuming user 26b specified his heading and location, user 26c would be presented as a communication option (such as is illustrated in FIG. 6b); if an opposite heading was specified, user 26d would be presented, etc.

In an alternative embodiment, illustrated in FIG. 8b, instead of specifying the location of user 26b, that user may specify to communicate with those users meeting his specified heading criteria that are ahead of him or behind him. Such flexibility is especially useful in the traffic hypotheticals posed above. Although defining a location or area in front of or behind user 26b can be based on locations or areas specified by user 26b, the server 24 may also use default settings to set such locations or areas (e.g., 20 miles in front of user 26b, etc.).

In some embodiments, it may be useful to connect with users merely dependent on orientation, particularly if communication options are limited by some other means other than location. In short, specification of a location is not strictly necessary.

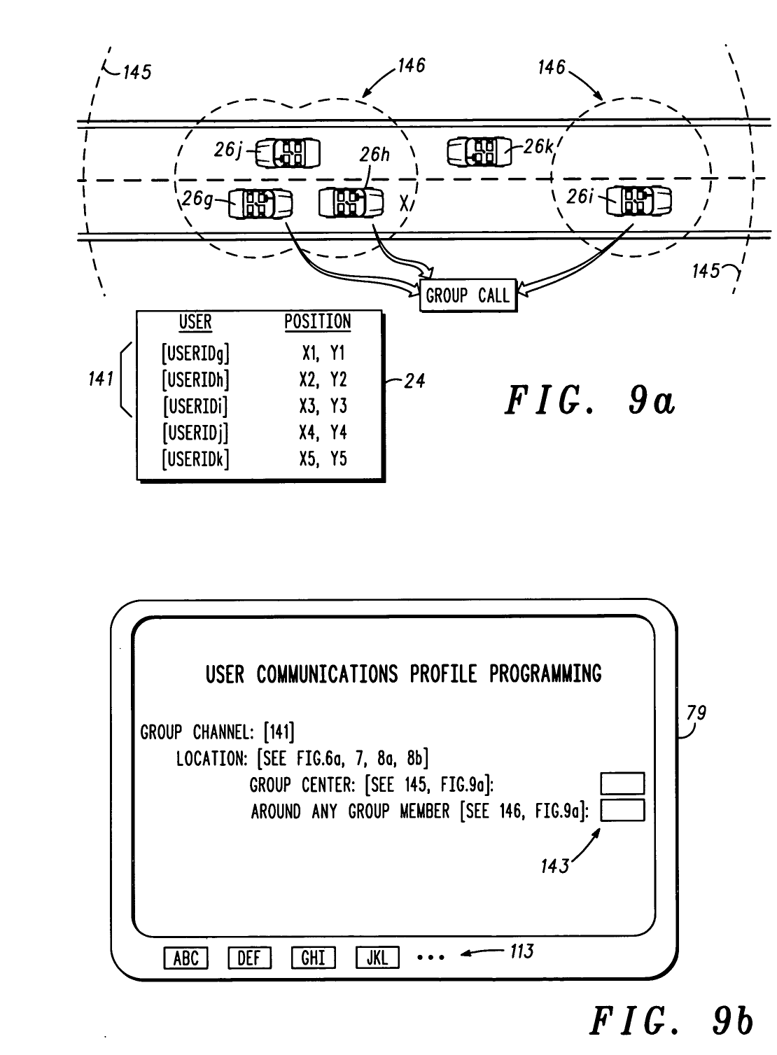

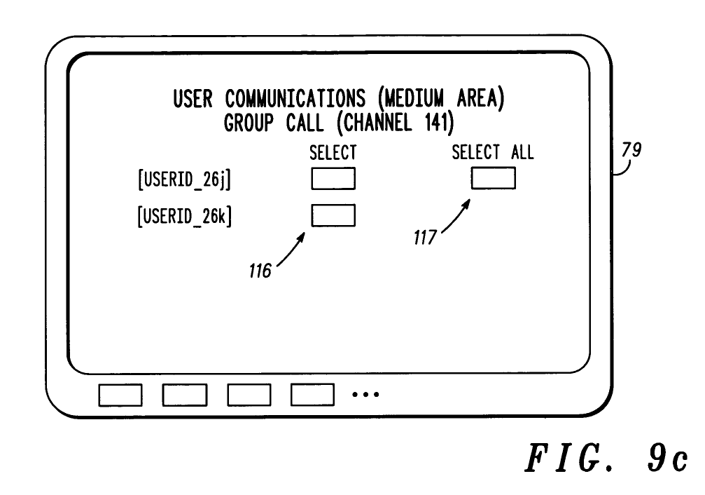

In another embodiment, several users may be joined in a call. For example, and as shown in FIG. 9a, suppose users 26g-i are traveling together on a trip. At various times during their trip they may wish to communicate with each other on a call. Any or all of them may thus talk with one another over a channel 141 established by themselves or by the server 24. Techniques for holding a group conversation using push-to-talk technology are well known. Even if none of users 26g-i are currently speaking, channel 141 will still exist to continually define their ability to have such a conversation.

In any event, it may be useful during their trip for users 26g-i to communicate with certain other system users on the basis of their location(s) or orientations, just as was the case with a single user as illustrated earlier. Accordingly, the same techniques can be used, but modified to include the fact that a group (or a member of the group) is initiating the communication request instead of a single user. For example, and as shown in FIG. 9b, suppose a user in the group (users 26g-i) wishes to communicate with system users (e.g., users 26j and k) not originally included with the group on their group channel 141, but which are within some distance of the group or otherwise some distance within some specified location. Thus, as shown in FIG. 9b, any of these users can choose to add such other users to their conversation. As before, one of the users must specify a location to enable the server 24 to determine which other users. As just noted, such location can be remote from the group (e.g., some miles ahead of the group) or can relate to the present position of the group. In this regard, the techniques disclosed earlier (i.e., in FIGS. 6a, 7, 8a, and 8b) can be used and are not shown in FIG. 9b for simplicity.

However, additional complexity exists if the group is interested in scanning for other users on the basis of the group location, since the group's location is not defined at a single point. Accordingly, the “location” of the group, and a scanning area around the group, can be defined in a number of different ways. For example, the location of the group can be specified by its center (X, FIG. 9a) to define an area 145 encompassing all of the group users, where X might comprise for example the average of the location coordinates of the group user. Or, an area 146 can be established around each of the users individually, which may or may not be contiguous depending on the distance between the users. Such group location definition options, as illustrated in FIG. 9a, will affect the other users that are ultimately deemed relevant by the server 24; for example, user 26k will not be presented to group users as a communication option if individual areas around each group member are chosen (146), but will be presented if a group center option (145) is chosen. Regardless of the group location scheme chosen, ultimately either the users or the server 24 (through default rules) can define relevant areas of interest around the group users, as discussed earlier.

Again, upon receipt of instructions (FIG. 9b) to scan for user substantially near the group, the server 24 again queries its database of users to see which would match the user or server defined area (145) around the group. Finding two other users meeting these criteria, the server 24 transmits the user IDs of these other users (users 26j and k) to the requesting user to provide the option to allow joining some or all of those other users, as shown in FIG. 9c.

Again, when dealing with a group, the other techniques disclosed earlier could also be used. For example, and although not shown in FIG. 9b, a group user (or the server 24) could define a relevant orientation of interest.

The disclosed techniques may also be used in conjunction with a user profile to even further tailor communication options, as is disclosed in above-incorporated U.S. patent application Ser. No. [______], entitled “Selectively Enabling Communications at a User Interface Using a Profile” [Attorney Docket TC00167]. Location- and orientation-based user preferences such as those disclosed herein can be stored and otherwise treated as part of the user profiles disclosed in that application. Moreover, although this disclosure has focused on connecting users with other users, it should be understood that the same location- and orientation-based techniques as disclosed herein can be used to connect with appropriate users on pubic communication channels, such as are disclosed in the above-mentioned application.

For example, there may exist a public Chicago traffic group channel (along with other channels) accessible to many users. A given user may wish to only communicate with certain users connected to that channel—such as those that are within a certain distance of the user. To effectuate this, the user may select the channel and otherwise specify his location requirement using the techniques disclosed herein. In this way, the user will be able to speak only with those users on the Chicago traffic channels that are nearest to him, which might be of greatest interest. Moreover, if the channel is itself location based (e.g., Chicago sports) and indexed in a manner such that the server 24 understands its location, the disclosed location/orientation techniques can be used to couple a given user to those channels, rather than to discrete users.

While largely described with respect to improving communications within vehicles, one skilled in the art will understand that many of the concepts disclosed herein could have applicability to other portable communicative user interfaces not contained within vehicles, such as cell phones, personal data assistants (PDAs), portable computers, etc., what can be referred to collectively as portable communication devices.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method of coupling communications between a first user and other users using a communication network, where the first and other users have user interfaces for interfacing with the network, comprising:
receiving at a server information indicative of the location of the first user and the other users;
defining an area around the location of first user;
querying the server to determine a subset of other users located within the area; and
enabling communications between the first user and at least some of the subset of other users through their user interfaces.

2. The method of claim 1, wherein at least one user interface is mounted in a vehicle.

3. The method of claim 1, wherein at least one user interface comprises a portable computer.

4. The method of claim 1, further comprising the step of displaying identification data associated with the subset of other users on a display associated with the first user's user interface.

5. The method of claim 4, wherein the first user can select which of the subset of other users to request communication with.

6. The method of claim 5, wherein the selected subset of other users can reject the first user's communication request using their user interfaces.

7. The method of claim 1, wherein the area is defined by a radius.

8. The method of claim 1, wherein the area is specified by the first user at his user interface.

9. The method of claim 1, wherein the area is specified by the server.

10. The method of claim 1, wherein the information indicative of a location comprises coordinates indicative of the position of the first or other users.

11. The method of claim 1, wherein the information indicative of a location comprises cell locations in the communication network.

12. A method of coupling a first user using a first user interface to other users in a communication network, comprising:
receiving information indicative of the location of the first user and the other users at a server;
defining an area around the first user;
presenting a plurality of channels to the first user; and
enabling the first user to select one of the plurality of channels to allow the first user to communicate only with other users within the area that have also selected the same of the plurality of channels.

13. The method of claim 12, wherein at least one user interface is mounted in a vehicle.

14. The method of claim 12, wherein at least one user interface comprises a portable computer.

15. The method of claim 12, further comprising displaying identification data associated with the other users within the area on a display associated with the first user's user interface.

16. The method of claim 15, wherein the first user can select which of the other users within the area to request communication with.

17. The method of claim 16, wherein the selected other users within the area can reject the first user's communication request using their user interfaces.

18. The method of claim 12, wherein the area is defined by a radius.

19. The method of claim 12, wherein the area is specified by the first user at his user interface.

20. The method of claim 12, wherein the area is specified by the server.

21. The method of claim 12, wherein the information indicative of a location comprises coordinates indicative of the position of the first or other users.

22. The method of claim 12, wherein the information indicative of a location comprises cell locations in the communication network.

23. A method of defining a group in a communication network accessible by a plurality of users each using a user interface, comprising:
allowing a first user, from his first user interface, to define the group on the basis of an area;
determining the location of other users;
allowing other users to join the group only if their determined location is within the area; and
permitting users that have joined the group to talk with the first user by pushing a button coupled to their user interface.

24. The method of claim 23, wherein at least one user interface is mounted in a vehicle.

25. The method of claim 23, wherein at least one user interface comprises a portable computer.

26. The method of claim 23, further comprising the step of displaying identification data associated with the other users within the area on a display associated with the first user's user interface.

27. The method of claim 23, wherein the area is defined by a radius.

28. The method of claim 23, wherein the area is specified by the first user at his user interface.

29. The method of claim 23, wherein the area is specified by the server.

30. A method of coupling a first user using a user interface to other users, comprising:
sending from the first user interface information indicative of a location of the first user;
presenting a plurality of channels to the first user based on the information indicative of the location of the first user; and
having the first user select one of the plurality of channels to allow the first user to communicate with other users who have joined the channel.

31. The method of claim 30, wherein the user interface is integrated in a vehicle.

32. The method of claim 30, wherein the user interface comprises a portable computer.

33. The method of claim 30, wherein the channel is substantially near the location when it bears a relationship to an area around the location.

34. The method of claim 30, wherein the information indicative of a location comprises coordinates indicative of the position of the first user.

35. The method of claim 30, wherein the location is remote from the first user.

36. The method of claim 30, wherein the location corresponds to the location of the first user.

37. A method of coupling communications between a first user and other users using a communication network, where the first and other users have user interfaces for interfacing with the network, comprising:
receiving at a server information indicative of the heading of the first user and the other users;
querying the server to determine a subset of other users having substantially the same heading as the first user; and
enabling communications between the first user and at least some of the subset of other users through their user interfaces.

38. The method of claim 37, wherein at least one user interface is mounted in a vehicle.

39. The method of claim 37, wherein at least one user interface comprises a portable computer.

40. The method of claim 37, further comprising displaying identification data associated with the subset of other users on a display associated with the first user's user interface.

41. The method of claim 40, wherein the first user can select which of the subset of other users to request communication with.

42. The method of claim 41, wherein the selected subset of other users can reject the first user's communication request using their user interfaces.

43. The method of claim 37, further comprising:
receiving at a server information indicative of the location of the other users;
defining an area;
querying the server to determine a subset of other users located within the area; and
enabling communications between the first user and at least some of the subset of other users through their user interfaces.

44. The method of claim 43, wherein the area is defined by a radius.

45. The method of claim 43, wherein the area is specified by the first user at his user interface.

46. The method of claim 43, wherein the area is specified by the server.

47. The method of claim 43, wherein the area corresponds to a location of the first user.

48. The method of claim 43, wherein the area corresponds to an area in front of the first user.

49. The method of claim 43, wherein the area corresponds to an area behind the first user.

50. A method of coupling communications between a plurality of first user to other users using a communication network, where the first users and other users have user interfaces for interfacing with the network, comprising:
receiving at a server information indicative of the locations and headings of the first users and the other users;
defining at least one area;
querying the server to determine a subset of other users located within the area and having substantially the same heading as the first users; and
enabling communications between the first users and at least some of the subset of other users through their user interfaces.

51. The method of claim 50, wherein at least one user interface is mounted in a vehicle.

52. The method of claim 50, wherein at least one user interface comprises a portable computer.

53. The method of claim 50, wherein the area covers and is defined by an average of the locations of the first users.

54. The method of claim 50, wherein the area corresponds to the locations of the first users.

55. The method of claim 50, wherein the area is remote from the first users.

56. The method of claim 50, wherein the area is in front of the first users.

57. The method of claim 50, wherein the area is behind the first users.

58. A method of coupling communications between a first user and other users using a communication network having a server, where the first and other users have user interfaces for interfacing with the network, comprising:
defining a geographic region into a plurality of cells and at least one super cell, the plurality of cells geographically located within the super cell;
establishing a first channel, the first channel associated with one of the plurality of cells;
establishing a second channel, the second channel associated with the at least one super cell;
receiving at the server information indicative of the location of the first user;
selecting one of the plurality of cells based on the information indicative of the location of the first user;
enabling communications from the first user to the server over the first channel; and
enabling communications from the server to the first user over the second channel.

59. The method of claim 58, wherein at least one user interface is mounted in a vehicle.

60. The method of claim 58, wherein at least one user interface comprises a portable computer.

61. The method of claim 58, wherein the step of enabling communications from the server to the first user over the second channel includes audio that the server receives from the other users that are located within the plurality of cells.

62. The method of claim 61, wherein the server prioritizes the audio received from the other users that are located within the plurality of cells.
